(19) United States
(12) Patent Application Publication
(10) Pub. No.: US 2017/0171288 A1
(43) Pub. Date: Jun. 15, 2017

(54) VIDEO PLAYING METHOD AND DEVICE FOR VIDEO PLAYING APPLICATION PROGRAM

(71) Applicant: CHEETAH MOBILE INC., Beijing (CN)

(72) Inventors: Shengsheng HUANG, Beijing (CN); Menghua HUANG, Beijing (CN)

(21) Appl. No.: 15/321,519

(22) PCT Filed: Jun. 25, 2015
(86) PCT No.: PCT/CN2015/082372

§ 371 Date: Dec. 22, 2016

(30) Foreign Application Priority Data
Jun. 27, 2014 (CN) 201410302706.3

(51) Int. Cl. H04L 29/08; H04L 29/06

(52) U.S. Cl. CPC H04L 67/02; H04L 65/60; H04N 21/4788

(57) ABSTRACT

Provided are method and device for playing a video by a video playing application program. The method includes: monitoring a current page, the current page being a webpage displayed in a webpage control of the video play application program; acquiring a video source address if the current page is set with the video source address; and according to the video source address, acquiring a video source, and invoking a player designated by the video playing application program for playing.

### CROSS-REFERENCE TO RELATED APPLICATION

This application claims priority to and benefits of Chinese Patent Application Serial No. 201410302706.3, entitled “method and device for playing video by video playing application program”, filed with the State Intellectual Property Office of P. R. China on Jun. 27, 2014 by SHELL INTERNET (BEIJING) SECURITY TECHNOLOGY CO., LTD.

### FIELD

The present disclosure relates to a video processing field, and more particularly relates to a method and a device for playing a video by a video playing application program.

### BACKGROUND

In the related art, a video playing application program cooperates with a video website for enriching content of video to be played and for playing more videos. When a video on the video website is played by the video playing application program, it is required to login to the video website, thereby causing a problem: which player should be chose.

For example, an HTML(Hyper Text Markup Language)5 page may be embedded in the video playing application program for displaying the content. If the video content is included in the page, a playing operation of the video is generally determined by a system browser when deciding which player to chose for playing the video content, which means that the system browser determines whether to play the video by the player pre-determined, or to play the video on a webpage directly, or to pop-up a dialog box prompting a user to choose one of players for playing the video.

However, the player designated by the system browser may be unavailable in the video playing application program; or may be available on a mobile terminal but unavailable on another mobile terminal. Thus, an extensibility of choosing the player in this way is limited.

In order to solve this problem, methods adopted by various products may be explained as follows.

(1) The playing operation is intercepted by using a customized rendering engine of the browser and realizing a playing interface in the browser automatically, when the video is to be played; a drawback of this method is that the customized rendering engine of the browser is needed, which brings a heavy workload and is difficult to realize.

(2) The playing operation is intercepted by intercepting via Hook technology an interface of a player invoked by a rendering engine of the browser if it is unable to customize the rendering engine of the browser; a drawback of this method is that the complicated Hook operations are required on the browser, which is difficult to realize stably and prone to be affected by a version upgrade of the rendering engine of the browser.

Thus, a drawback in the related art is lack of a simple and convenient method of designating a player in a video playing application program for playing a video.

### SUMMARY

Embodiments of the present disclosure provide a method and a device for playing a video by a video playing application program, so as to designate a player in a simple and convenient way when the video is played by the video playing application program.

Embodiments of the present disclosure provide a method for playing a video by a video playing application program, including: monitoring a current page, in which the current page is a webpage displayed in a webpage control of the video playing application program; acquiring a video source address if the current page is set with the video source address; and acquiring a video source according to the video source address, and invoking a player designated by the video playing application program.

Embodiments of the present disclosure provide a device for playing a video by a video playing application program, including: a monitoring module, configured to monitor a current page, in which the current page is a webpage displayed in a webpage control of a video playing application program; an acquiring module, configured to acquire a video source address if the current page is set with the video source address; and a playing module, configured to acquire a video source according to the video source address, and to invoke a player designated by the video playing application program. Embodiments of the present disclosure also provide a storage medium, configured to store an application program, in which the application program is configured to execute the method according to the embodiments of the present disclosure.

Embodiments of the present disclosure also provide a video playing apparatus, including: one or more processors; memory; and one or more modules, stored in the memory, when executed by the one or more processors, performing following operations:

monitoring a current page, in which the current page is a webpage displayed in a webpage control of a video playing application program; acquiring a video source address if the current page is set with the video source address; and acquiring a video source according to the video source address, and invoking a player designated by the video playing application program.

### BRIEF DESCRIPTION OF THE DRAWINGS

Embodiments of the present disclosure will be described with reference to the accompanying drawings, in which:

FIG. 1 is a flow chart of a method for playing a video by a video playing application program according to an embodiment of the present disclosure; and

FIG. 2 is a block diagram of a device for playing a video by a video playing application program according to an embodiment of the present disclosure.

### DETAILED DESCRIPTION

In order to clarify technical solutions of the present disclosure and advantages thereof, reference will now be made in detail to exemplary embodiments, examples of which are illustrated in the accompanying drawings. Apparently, implementations set forth in the following description are merely a part of embodiments of the present disclosure, and do not represent all implementations consistent with the disclosure.

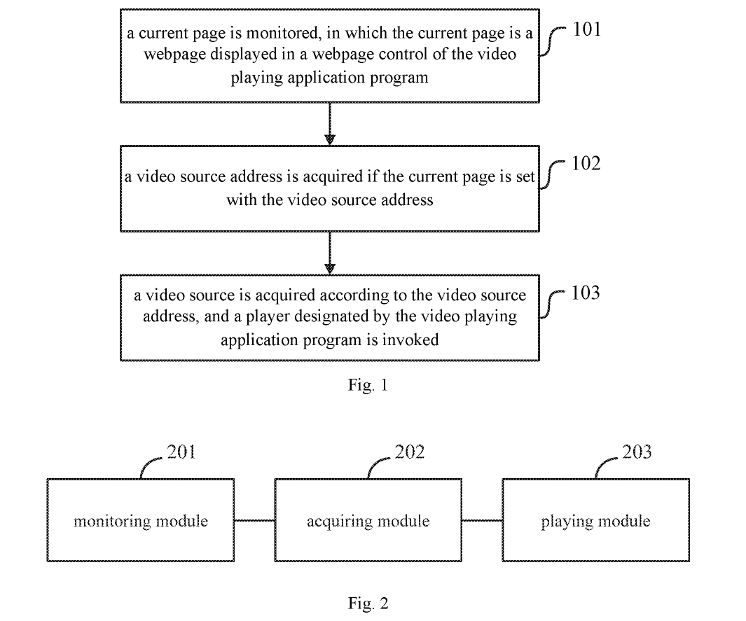

FIG. 1 is a flow chart of a method for playing a video by a video playing application program according to an embodiment of the present disclosure. As shown in FIG. 1, the method includes the followings.

In act 101, a current page is monitored, in which the current page is a webpage displayed in a webpage control of the video playing application program.

In act 102, a video source address is acquired if the current page is set with the video source address.

In act 103, a video source is acquired according to the video source address, and a player designated by the video playing application program is invoked. In an implementation, the above acts may be implemented by injecting a script in the current page. Specifically, the script may be injected in the current page through a standard interface of a browser control, which is easy to be realized by skilled in the art.

In an implementation, monitoring a current page may include monitoring a video tag of the current page. It may be determined that the current page is set with the video source address, if the video tag is set with the video source address. Acquiring a video source address may include acquiring the video source address corresponding to the video source with a state defined in the video tag as Play.

In an implementation, the video tag is taken as an example since the video tag is the common and easy to implement in the current page, but other examples are also available. In fact, the video tag is mainly applied to on the implement of an HTML5 page, but under other rules or standards, other tags or controls are also able to be applied in the implement, as long as an aim of monitoring the current page and acquiring the video source address may be realized. In this embodiment, the video tag is only used to instruct those skilled in the art to implement the present disclosure in this implementation. The video tag shall not be construed to limit the present disclosure. A corresponding method may be determined by combining practice in implementations.

In an implementation, the video tag of the current page is monitored if the webpage displayed in the webpage control is updated.

In an implementation, the video source address corresponding to the video source with a state defined in the video tag as Play is acquired according to a DOM (Document Object Model) structure of the current page.

In an implementation, the method further includes creating a timer, in which the video tag of the current page may be monitored when the timer is executed.

In an implementation, the method further includes modifying the state defined in the video tag from Play to Pause if it is determined that the video tag is set with the video source address.

In a specific implementation, this act is intended to monitor an operation of starting to play, since it is easy to determine that the video tag is set with the video source address at this moment. Specifically, a parameter src corresponding to the video source address of the video tag is monitored, and when it is found that the parameter src is set with the video source address, it indicates that the video is started to play, then the state defined in the video tag may be modified from Play to Pause.

In an implementation, invoking a player designated by the video playing application program for playing the video source may include: providing a playing interface for the current page through an expansion interface of a browser control; and invoking the player designated by the video playing application program for playing the video source, through the playing interface.

Implementations are described in detail below by taking the video tag as an example.

The playing interface may be needed when the player designated by the video playing application program is invoked, so the playing interface may be provided for the current page through the expansion interface of the browser control in advance. Specifically, the video playing application program may use a system default browser control to provide the playing interface for the current page. Providing the playing interface for the current page may include providing an entrance to invoke the player designated by the video playing application program for a page script program in the current page. The page script program is abbreviated to script, which is an expansion of a batch file and refers to a program in plain text. Generally, a computer script program is a combination of a series of determined acts controlling a computer for performing computation operations, and a logic branch may be realized in the computer script program. In brief, the script consists of text commands which are visible (for example, the text command may be opened, viewed and edited in a Notepad). When the computer script program is executed, the text commands are translated into instructions which are recognizable for the computer by an interpreter in the system, and are executed in sequence of the program. Generally, the script may be temporarily invoked and executed by an application program. Various scripts may be applied to webpage design widely.

In an implementation, there are various ways for providing the playing interface. For example, the playing interface may be provided for the script of the current page through the expansion interface of the browser control. An implementation of the script will be illustrated in followings.

Providing the playing interface for the script of the current page through the expansion interface of the browser control may be implemented as follows.

A callable interface is provided for a script in javascript. For example, a WebView control of Android system may provide an interface for the javascript running in the browser control based on a method “addJavascriptInterface”. Thus, the video playing application program may pack the function of invoking the player as an expansion interface, and provide the expansion interface for the script in the current page.

Specifically, the method for playing the video by the video playing application program may be realized by writing the script, i.e., the acts of monitoring the current page, acquiring the video source address and invoking the interface may be realized automatically by writing the script.

Thus, in an implementation, when the webpage in the webpage control is updated completely, the script which may realize the above functions may be injected through a standard interface of the browser control.

The script may further realize the following functions: creating a timer T, in which the video tag of the current page is monitored when the timer is executed. After the timer is set, implementations of the solutions provided in embodiments may be controlled by setting the timer, as needed.

Thus, by executing the script, the video tag in the current page may be monitored when the timer T is executed. Assume that the video tag is set with the video source address, the video source address corresponding to the video source with a state defined in the video tag as Play may be acquired according to a DOM structure of the current page, and the state defined in the video tag is modified from Play to Pause; and the video source may be acquired according to the video source address and the video may be played by the player designated by the video playing application program.

The video source address corresponding to the video source with a state defined in the video tag as Play may, taking the video tag of a standard HTML5 player control as example, have various properties such as src, poster, preload, autoplay, loop, controls, height and width, etc.. The property src is configured to assign an address of the video; the property poster is configured to assign an image; the property autoplay is configured to set whether to play the video automatically, and when the property autoplay exists, the video is played automatically; the property loop is configured to assign whether to play the video in a loop.

A new video tag is provided in HTMLS, and the program codes are shown as follows.

```
  <body style=” background-color:#8EEE5EE;” >
    <div id=” big_wrapper” >
      <video src=” http://media.w3.org/2010/05/sintel/trailer.ogv”
width=” 640” height=” 360” poster=” images/me.jpg”
autoplay=” autoplay” loop=” loop” >
    </div>
  </body>
```

If it is detected that the state defined in the video tag is Play (automatic play or play at a certain time), the video source address (i.e., “http://media.w3.org/2010/05/sintel/trailer.ogv” in the above example) corresponding to the parameter src of the video tag may be acquired.

By modifying the state defined in the video tag from Play to Pause, the video on the webpage may be not played according to the existing technology, and the video presented to the user is that played by the player designated by the video playing application program, so that the user may have a better experience.

Based on a same inventive concept, the present disclosure also provides a device for playing a video by a video playing application program. Since the device and the method have the similar principle for solving problems, concerning implementations of the device, reference may be made to the implementations of the method, and overlaps of the device and the method will not described herein.

FIG. 2 is a block diagram of a device for playing a video by a video playing application program according to an embodiment of the present disclosure. As shown in FIG. 2, the device may include: a monitoring module 201, configured to monitor a current page, in which the current page is a webpage displayed in a webpage control of a video playing application program; an acquiring module 202, configured to acquire a video source address if the current page is set with the video source address; and a playing module 203, configured to acquire a video source according to the video source address, and to invoke a player designated by the video playing application program for playing the video source.

In an implementation, the monitoring module 201 is further configured to monitor a video tag of the current page.

The acquiring module 202 is further configured to determine that the current page is set with the video source address if the video tag is set with the video source address; and to acquire the video source address corresponding to the video source with a state defined in the video tag as Play, when acquiring the video source address.

In an implementation, the monitoring module 201 is further configured to monitor the video tag of the current page if the webpage displayed in the webpage control is updated.

In an implementation, the acquiring module 202 is further configured to acquire the video source address corresponding to the video source with a state defined in the video tag as Play according to a DOM structure of the current page.

In an implementation, the device further includes: a timer; and the monitoring module 201 is further configured to monitor the video tag of the current page when the timer is executed.

In an implementation, the device further includes: a pausing module, configured to modify the state defined in the video tag from Play to Pause if it is determined that the video tag is set with the video source address.

In an implementation, the playing module 203 is further configured to provide a playing interface for the current page through an expansion interface of a browser control and to invoke the player designated by the video playing application program through the playing interface.

For convenience, various parts of the device are classified as modules or units according to functions and described respectively. Of course, the functions of various modules or units may be realized in one or more software or hardware means when implementing the present disclosure.

The device will be described below with reference to embodiments of playing the video by the video playing application program.

The video playing application program provides the playing interface for the current page through an expansion interface of a browser control.

Once the webpage displayed in the webpage control is updated, the video playing application program may inject a script in the current page through a standard interface of the browser control. The script is configured to monitor the current page, to determine whether the current page is set with the video source address, to acquire the video source address, and to invoke the player designated by the video playing application program for playing.

The user may choose the video to be watched from the page content displayed by the video playing application program. Assume that the video is acquired by cooperating with a third-party video website, the video tag is set with the video source address if the user clicks the video.

If determining that the video tag is set with the video source address, the script may modify the state defined in the video tag from Play to Pause so as to: pause the video played by a playing control; acquire the video source address corresponding to the video source with a state defined in the video tag as Play, acquire a video source according to the video source address, and invoke a player designated by the video playing application program.

Based on a same inventive concept, the present disclosure also provides a storage medium configured to store an application program, in which the application program is configured to execute the method for checking the influence of the deletion of a cache file according to the first aspect of the present disclosure.

Based on a same inventive concept, the present disclosure also provides a video playing apparatus, including: one or more processors; memory; and one or more modules, stored in the memory, when executed by the one or more processors, performing following operations.

In act S101′, a current page is monitored, in which the current page is a webpage displayed in a webpage control of the video playing application program.

In act S102′, a video source address is acquired if the current page is set with the video source address.

In act S103′, a video source is acquired according to the video source address, and a player designated by the video playing application program is invoked.

The technical solution provided by the present disclosure is irrelevant to a change of a rendering engine of a browser. By acquiring a video source address through a standard interface, a player designated by the video playing application program may be invoked through a playing interface, such that the technical solution provided by the present disclosure is easy to realize without modifying a bottom layer. Also, the technical solution is unlimited to an operating system and may be used in Android system or iOS system, which is extensible and cross-platform.

Those skilled in the art should understand that embodiments of the present disclosure may provide a method, a system or a computer program. Thus, each part of the present disclosure may be realized by the hardware, software or combinations thereof. Besides, the present disclosure is also suitable for the computer program product implemented in one or more computer-available storage mediums (including but not limited to a disk, CD-ROM, and an optical memory, etc.) having computer-readable program codes stored therein.

The present disclosure is described with reference to a flow chart and/or a block diagram corresponding respectively to a method, a device (a system) and a computer program provided by embodiments of the present disclosure. It should be understood that each flow and/or each block in the flow chart and/or the block diagram and a combination thereof may be realized by computer program instructions. The computer program instructions may be provided to the processor of a general-purpose computer, a special-purpose computer, an embedded processor, or other programmable data processing devices, so that a device configured to realize functions designated in one or more flows in the flow chart and/or one or more blocks in the block diagram may be generated by executing the instructions by the processor of the computer or other programmable data processing devices.

The computer program instructions may be stored in a computer readable storage medium instructing the computer or other programmable data processing devices to work in a specific mode, so that a product including an instruction device is created by the computer program instructions stored in the computer readable storage medium. The instruction device is configured to realize the functions designated in one or more flows in the flow chart and/or one or more blocks in the block diagram.

The computer program instructions may be loaded in the computer or other programmable data processing devices, so that a series of operations may executed by the computer or other programmable data processing devices for achieving the processes realized by the computer. Thus, the computer program instructions executed by the computer or other programmable data processing devices may provide steps for realizing the functions designated in one or more flows in the flow chart and/or one or more blocks in the block diagram.

The above embodiments are explanatory and cannot be construed to limit the present disclosure. Thus, changes, alternatives, and modifications can be made in the embodiments without departing from scope of the present disclosure by those skilled in the art. Obviously, the present disclosure covers all the changes, alternatives, and modifications within the technical scope of the present disclosure.

1. A method for playing a video by a video playing application program, comprising:
monitoring a current page, wherein the current page is a webpage displayed in a webpage control of the video playing application program;
acquiring a video source address if the current page is set with the video source address; and
acquiring a video source according to the video source address, and invoking a player designated by the video playing application program.

2. The method according to claim 1, wherein
monitoring a current page comprises monitoring a video tag of the current page;
it is determined that the current page is set with the video source address, if the video tag is set with the video source address; and
acquiring a video source address comprises acquiring the video source address corresponding to the video source with a state defined in the video tag as Play.

3. The method according to claim 2, wherein the video tag of the current page is monitored if the webpage displayed in the webpage control is updated.

4. The method according to claim 2, wherein the video source address corresponding to the video source with a state defined in the video tag as Play is acquired according to a DOM structure of the current page.

5. The method according to claim 2, further comprising:
creating a timer; wherein
the video tag of the current page is monitored when the timer is executed.

6. The method according to claim 2, further comprising:
modifying the state defined in the video tag from Play to Pause if it is determined that the video tag is set with the video source address.

7. The method according to claim 1, wherein invoking a player designated by the video playing application program comprises:
providing a playing interface for the current page through an expansion interface of a browser control; and
invoking the player designated by the video playing application program through the playing interface.

8. A device for playing a video by a video playing application program, comprising:
non-transitory computer readable medium comprising computer-executable instructions stored thereon that when executed by a processor implement:
a monitoring module, configured to monitor a current page, wherein the current page is a webpage displayed in a webpage control of a video playing application program;
an acquiring module, configured to acquire a video source address if the current page is set with the video source address; and
a playing module, configured to acquire a video source according to the video source address, and to invoke a player designated by the video playing application program.

9. The device according to claim 8, wherein
the monitoring module is further configured to monitor a video tag of the current page;
the acquiring module is further configured to determine that the current page is set with the video source address if the video tag is set with the video source address; and to acquire the video source address corresponding to the video source with a state defined in the video tag as Play, when acquiring the video source address.

10. The device according to claim 9, wherein the monitoring module is further configured to monitor the video tag of the current page if the webpage displayed in a webpage control is updated.

11. The device according to claim 9, wherein the acquiring module is further configured to acquire the video source address corresponding to the video source with a state defined in the video tag as Play according to a DOM structure of the current page.

12. The device according to claim 9, further comprising:
a timer; wherein
the monitoring module is further configured to monitor the video tag of the current page when the timer is executed.

13. The device according to claim 9, further comprising:
a pausing module, configured to modify the state defined in the video tag from Play to Pause if it is determined that the video tag is set with the video source address.

14. The device according to claim 8, wherein the playing module is further configured to provide a playing interface for the current page through an expansion interface of a browser control and to invoke the player designated by the video playing application program through the playing interface.

15. A storage medium, configured to store an application program, wherein the application program is configured to execute the method according to claim 1.

16. (canceled)

17. The method according to claim 2, wherein invoking a player designated by the video playing application program comprises:
providing a playing interface for the current page through an expansion interface of a browser control; and
invoking the player designated by the video playing application program through the playing interface.

18. The method according to claim 3, wherein invoking a player designated by the video playing application program comprises:
providing a playing interface for the current page through an expansion interface of a browser control; and
invoking the player designated by the video playing application program through the playing interface.

19. The method according to claim 4, wherein invoking a player designated by the video playing application program comprises:
providing a playing interface for the current page through an expansion interface of a browser control; and
invoking the player designated by the video playing application program through the playing interface.

20. The method according to claim 5, wherein invoking a player designated by the video playing application program comprises:
providing a playing interface for the current page through an expansion interface of a browser control; and
invoking the player designated by the video playing application program through the playing interface.

21. The method according to claim 6, wherein invoking a player designated by the video playing application program comprises:
providing a playing interface for the current page through an expansion interface of a browser control; and
invoking the player designated by the video playing application program through the playing interface.
